(19) United States
(12) Patent Application Publication
(10) Pub. No.: US 2009/0291268 A1
(43) Pub. Date: Nov. 26, 2009

(54) RESIN SURFACE LAYER AND METHOD OF FABRICATING THE SAME, COMPOSITE HAVING THE RESIN SURFACE LAYER AND METHOD OF FABRICATING THE SAME

(75) Inventors: Chung-Chih Feng, Kaohsiung (TW); Pai-Hsiang Wu, Kaohsiung (TW); Chien-Chia Huang, Kaohsiung (TW); Chin-Shih Wang, Kaohsiung (TW)

Correspondence Address: WPAT, PC;INTELLECTUAL PROPERTY ATTORNEYS, 2030 MAIN STREET, SUITE 1300, IRVINE, CA, 92614, US

(73) Assignee: SAN FANG CHEMICAL INDUSTRY CO., LTD., Kaohsiung (TW)

(21) Appl. No.: 12/360,763

(22) Filed: Jan. 27, 2009

(30) Foreign Application Priority Data
May 26, 2008 (TW) 097119425

(51) Int. Cl. B32B 3/00; B05D 3/06

(52) U.S. Cl. 428/195.1; 427/550

(57) ABSTRACT

A resin surface layer and a method of fabricating the same, and a composite having the resin surface layer and a method of fabricating the same, are provided. The method of fabricating the resin surface layer includes: (a) providing a base, made of a resin and including a plurality of additive particles randomly distributed in the base, wherein the additive particles are selected from a group consisting of pigments, dyes, colorants, coloring matters, and pearl powders; (b) moving the base constantly, and providing a magnetic field generating device to generate an exterior magnetic field that has an uneven distribution of magnetic field intensity, and is applied to the base to change the orientation of the additive particles, so that the additive particles are arranged in a predetermined form; and (c) drying the base to make a surface of the base exhibit a visual effect of 3D texture. Thus, the visual effect of any 3D texture can be achieved by controlling the orientation of the additive particles.

### BACKGROUND OF THE INVENTION

1. Field of the Invention

The present invention relates to a resin surface layer and a method of fabricating the same. More particularly, the present invention relates to a resin surface layer capable of exhibiting a visual effect of 3D texture by using an exterior magnetic field and a method of fabricating the same.

2. Description of the Related Art

FIG. 1 shows a schematic cross-sectional view of a conventional composite. The conventional composite 1 is artificial leather, including a bottom cloth layer 11, an intermediate layer 12, and a surface layer 13. The bottom cloth layer 11 generally is a woven fabric, a nonwoven fabric, leather, a microfiber, or a resin. The intermediate layer 12 is formed on the bottom cloth layer 11, and generally is a foam layer. The surface layer 13 is located on the intermediate layer 12 and is made of PU resin.

In order to improve the real-life quality of the conventional composite 1, a texture 14 is formed on the surface of the surface layer 13. The texture 14 is a physical texture of bumps and pits which is mostly formed by means of texture contact and transfer, such as printing, embossing, or release paper laminating, or directly polishing the surface of the surface layer 13. However, the above methods of forming a texture have the following shortcomings. First, the methods will influence the flatness of the surface layer 13. Second, the pattern of the formed texture is limited, and cannot achieve any 3D textures.

Therefore, it is necessary to provide a resin surface layer and a method of fabricating the same to solve the above problems.

### SUMMARY OF THE INVENTION

The present invention is directed to a method of fabricating a resin surface layer, which includes: (a) providing a base, made of a resin and including a plurality of additive particles randomly distributed in the base, wherein the additive particles are selected from a group consisting of pigments, dyes, colorants, coloring matters, and pearl powders; (b) moving the base constantly, and providing a magnetic field generating device to generate an exterior magnetic field that has an uneven distribution of magnetic field intensity, the exterior magnetic field being applied to the base to change the orientation of the additive particles, so that the additive particles are arranged in a predetermined form; and (c) drying the base to make a surface of the base exhibit a visual effect of 3D texture. Thus, the visual effect of any 3D textures can be achieved by controlling the orientation of the additive particles.

The present invention is further directed to a resin surface layer, which includes a base and a plurality of additive particles. The base has a surface and is made of a resin. The additive particles are selected from a group consisting of pigments, dyes, colorants, coloring matters, and pearl powders. The additive particles are controlled by an exterior magnetic field so as to be arranged in a predetermined form in the base, so that the surface of the base exhibits a visual effect of 3D texture.

The present invention is also directed to a composite having the above resin surface layer.

### BRIEF DESCRIPTION OF THE DRAWINGS

FIG. 1 is a schematic cross-sectional view of a conventional composite;

FIGS. 2 to 4 are schematic views illustrating a first embodiment of a method of fabricating a resin surface layer according to the present invention;

FIG. 5 is a schematic view of a second embodiment of a resin surface layer according to the present invention;

FIG. 6 is a schematic view of a third embodiment of a resin surface layer according to the present invention;

FIG. 7 is a schematic view of a second type of magnetic field generating device according to the present invention;

FIG. 8 is a schematic view of a third type of magnetic field generating device according to the present invention;

FIG. 9 is a schematic view of a fourth type of magnetic field generating device according to the present invention;

FIGS. 10 and 11 are schematic views illustrating a first embodiment of a method of fabricating the composite having a resin surface layer according to the present invention;

FIGS. 12 and 13 are schematic views illustrating a second embodiment of a method of fabricating the composite having a resin surface layer according to the present invention;

FIGS. 14 and 15 are schematic views illustrating a third embodiment of a method of fabricating the composite having a resin surface layer according to the present invention; and

FIGS. 16 to 18 are schematic views illustrating a fourth embodiment of a method of fabricating the composite having a resin surface layer according to the present invention.

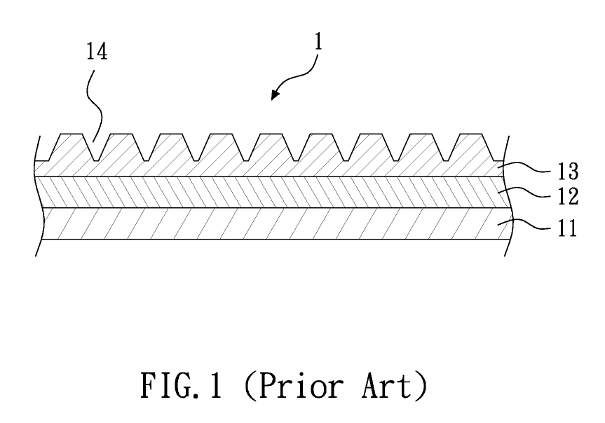

### DETAILED DESCRIPTION OF THE INVENTION

The present invention relates to a method of fabricating a resin surface layer, which includes the following steps:

(a) providing a base, made of a resin and including a plurality of additive particles randomly distributed in the base, wherein the additive particles are selected from a group consisting of pigments, dyes, colorants, coloring matters, and pearl powders;

(b) moving the base constantly, and providing a magnetic field generating device to generate an exterior magnetic field that has an uneven distribution of magnetic field intensity, and is applied to the base to change the orientation of the additive particles, so that the additive particles are arranged in a predetermined form; and

(c) drying the base to make a surface of the base exhibit a visual effect of 3D texture.

In the present invention, the material of the base in Step (a) is selected from a group consisting of PU, polyethylene (polyvinyl chloride), acrylic resin, polycarbonate, and epoxy resin.

In a preferred embodiment, after Step (a), a step of forming the base on a carrier is further included, in which the carrier is selected from a group consisting of a release paper, a woven fabric, a nonwoven fabric, leather, a microfiber, and a resin.

In the present invention, in Step (b), the magnetic field generating device includes but is not limited to the following four types: plate magnetic material, multi-piece magnetic material, caterpillar type magnetic material or roller type magnetic material. The multi-piece magnetic material of the second type has a plurality of magnetic materials that may be arranged in a row or an array. The above-mentioned plate magnetic material of the first type and the multi-piece magnetic material of the second type may be fixed or move along with the base simultaneously or non-simultaneously. The above-mentioned caterpillar type magnetic material of the third type comprises a plurality of magnetic materials and a caterpillar, and the magnetic materials are located on the caterpillar, and the caterpillar drives the magnetic materials, so that the moving velocity of the magnetic materials is equal to the moving velocity of the base. The above-mentioned roller type magnetic material of the fourth type comprises a magnetic material and a roller, and the magnetic material is annular and located on the periphery of the roller. The roller drives the magnetic material, so that the tangent moving velocity of the magnetic material is equal to the moving velocity of the base.

As used in the present invention, the word “orientation” refers to the distribution (density) of the additive particles, or the angle of the additive particles.

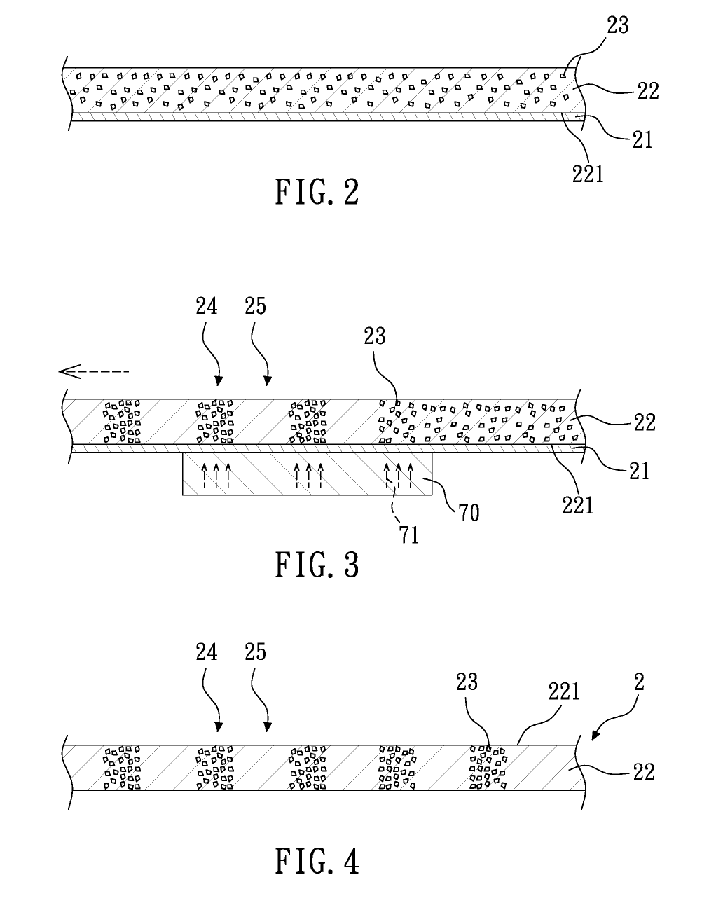

FIGS. 2 to 4 show schematic views illustrating a first embodiment of a method of fabricating a resin surface layer according to the present invention. First, referring to FIG. 2, a base 22 is provided. The material of the base 22 is a single-component PU resin (U-BEST POLYMER INDUSTRY CO., LTD®, AT-508E™). The base 22 includes a plurality of additive particles 23. In this embodiment, the additive particles 23 are pearl powder (model: SANFANG SA101S) with a percentage from 0.1% to 4%. The additive particles 23 are randomly distributed in the base 22.

Thereafter, the base 22 is formed on a release paper (Favini® ASTRAKAN™) 21, so that the base 22 has a surface 221. As the surface of the release paper 21 does not have a texture, the surface 221 of the base 22 is smooth and does not have a physical texture of bumps and pits. Alternatively, the surface of the release paper 21 may have a texture, and therefore, the surface 221 of the base 22 has a physical texture of bumps and pits.

Then, referring to FIG. 3, the base 22 and the release paper 21 are moved constantly (for example, moved to the left side of the figure constantly). Meanwhile, a magnetic field generating device 70 is provided so as to generate an exterior magnetic field 71. In this embodiment, the magnetic field generating device 70 is the above-mentioned plate magnetic material of the first type, and it's fixed. The exterior magnetic field 71 has an uneven distribution of magnetic field intensity, and is applied to the base 22, so as to induce the additive particles 23 and change the distribution of the additive particles 23, so that the additive particles 23 have a predetermined difference in density distribution. As shown in the figure, additive particles 23 are dense in a first region 24, while no additive particle is in a second region 25.

Next, referring to FIG. 4, the base 22 is dried and the release paper 21 is removed, so as to form a surface layer 2. After the base 22 is inverted, the surface 221 of the base 22 can exhibit the visual effect of 3D texture. As shown in the figure, the first region 24 is a bright area, and the second region 25 is a dark area and exhibits a 3D texture of a plurality of cuboids. Moreover, a physical texture of bumps and pits can be further formed on the surface 221 of the base 22 by other ways, if necessary.

Referring to FIG. 4 again, a schematic view of the first embodiment of a resin surface layer according to the present invention is shown. The resin surface layer 2 includes a base 22 and a plurality of additive particles 23. The base 22 has a surface 221, and the material of the base 22 is a resin selected from a group consisting of PU, polyethylene (polyvinyl chloride), acrylic resin, polycarbonate, and epoxy resin. In this embodiment, the material of the base 22 is a single-component PU resin (U-BEST POLYMER INDUSTRY CO., LTD®, AT-508E™). The surface 221 of the base 22 is smooth and does not have the physical texture of bumps and pits.

The additive particles 23 are located in the base 22. The additive particles 23 are selected from a group consisting of pigments, dyes, colorants, coloring matters, and pearl powders. In this embodiment, the additive particles 23 are pearl powder (model: SANFANG SA101S) with a percentage from 0.1% to 4%. The additive particles 23 are controlled by an exterior magnetic field 71 so as to be arranged in a predetermined form, so that the surface 221 of the base 22 can exhibit the visual effect of 3D texture. That is, the additive particles 23 are not randomly distributed in the base 22. In this embodiment, the additive particles 23 have a predetermined difference in density distribution. That is, the density of the additive particles 23 in the first region 24 is different from that of the additive particles 23 in the second region 25, so that the first region 24 is a bright area, and the second region 25 is a dark area and exhibits the 3D texture of cuboids.

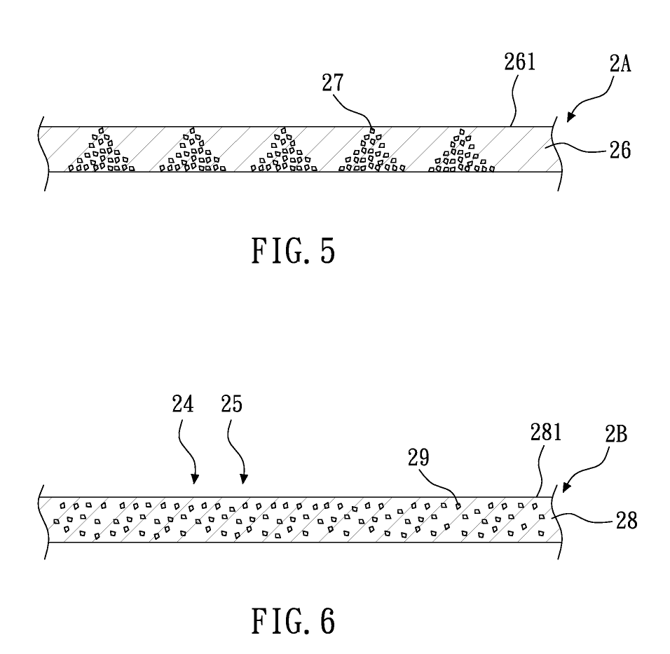

FIG. 5 shows a schematic view of a second embodiment of a resin surface layer according to the present invention. The resin surface layer 2A includes a base 26 and a plurality of additive particles 27. The base 26 is the same as the base 22 of the first embodiment. The additive particles 27 are substantially the same as the additive particles 23 of the first embodiment, except that the additive particles 27 are arranged into a triangular shape. Thus, the 3D texture of a plurality of prisms can be seen as if viewed from a surface 261 of the base 26.

FIG. 6 shows a schematic view of a third embodiment of a resin surface layer according to the present invention. The resin surface layer 2B includes a base 28 and a plurality of additive particles 29. The base 28 is the same as the base 22 of the first embodiment. The additive particles 29 are substantially the same as the additive particles 23 of the first embodiment, except that the orientation of the additive particles 29 is different. In this embodiment, after the additive particles 29 are polarized, the angles of the additive particles 29 are changed, so that the additive particles 29 have a predetermined difference in angle distribution. As shown in the figure, the angle of the additive particles 29 in the first region 24 is different from the angle of the additive particles 29 in the second region 25. Therefore, although the additive particles 29 are uniformly distributed in the base 28, the first region 24 is a bright area and the second region 25 is a dark area. Thus, a surface 281 of the base 28 exhibits the 3D texture of a plurality of cuboids, which is the same effect as that of the first embodiment.

Accordingly, in the present invention, the visual effects of any 3D textures can be achieved by controlling the exterior magnetic field in order to control the orientation of the additive particles.

FIG. 7 shows a schematic view of a second type of magnetic field generating device according to the present invention. The second type of magnetic field generating device 72 is multi-piece magnetic material, comprising a plurality of magnetic materials 73 that may be arranged in a row or an array. The magnetic materials 73 may be fixed or move along with the base 22 and the release paper 21 simultaneously or non-simultaneously.

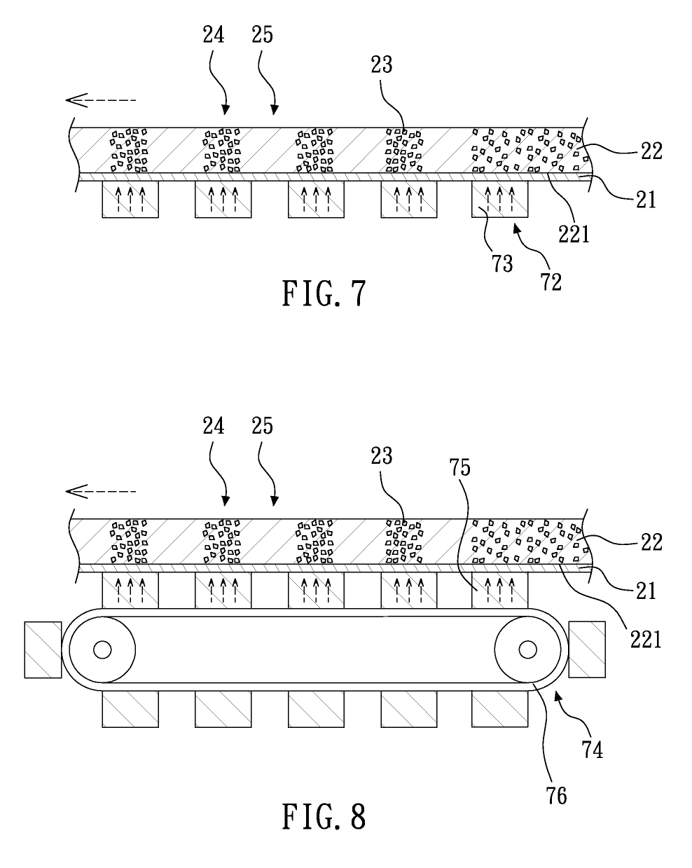

FIG. 8 shows a schematic view of a third type of magnetic field generating device according to the present invention. The third type of magnetic field generating device 74 is caterpillar type magnetic material, comprising a plurality of magnetic materials 75 and a caterpillar 76. The magnetic materials 75 are located on the caterpillar 76, and the caterpillar 76 drives the magnetic materials 75, so that the moving velocity of the magnetic materials 75 is equal to the moving velocity of the base 22 and the release paper 21.

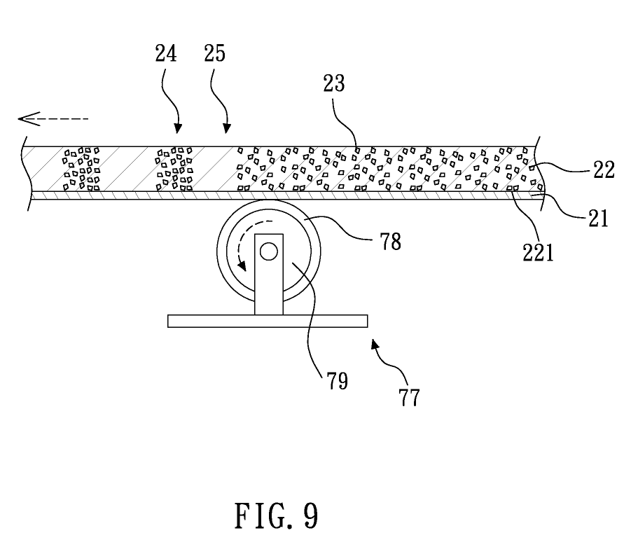

FIG. 9 shows a schematic view of a fourth type of magnetic field generating device according to the present invention. The fourth type of magnetic field generating device 77 is roller type magnetic material, comprising a magnetic material 78 and a roller 79. The magnetic material 78 is annular and located on the periphery of the roller 79. The roller 79 drives the magnetic material 78 as it rotates, so that the tangent moving velocity of the magnetic material 78 is equal to the horizontal moving velocity of the base 22 and the release paper 21.

The above-mentioned resin surface layer fabricated as shown from FIG. 4 to FIG. 6 may be used alone, or the resin surface layer may be used as a layer in a composite, which is described in the following embodiments.

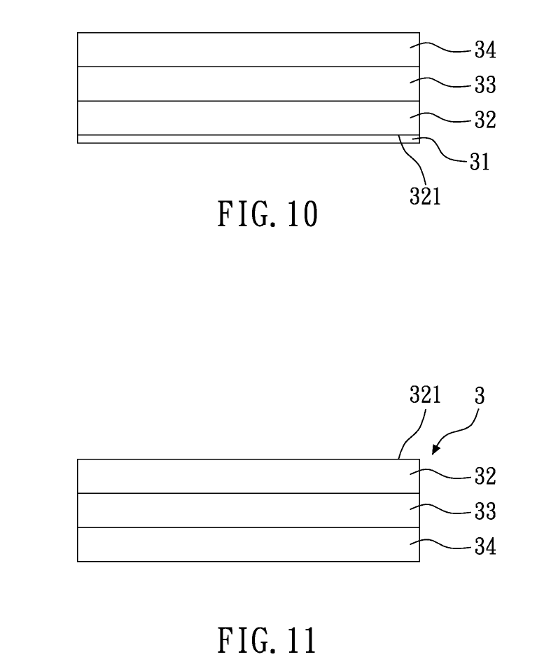

FIGS. 10 and 11 show schematic views illustrating a first embodiment of a method of fabricating the composite having a resin surface layer according to the present invention. First, referring to FIG. 10, a release paper (Favini® ASTRAKAN™) 31 is provided. Next, a base is provided. The material of the base is a resin selected from a group consisting of PU, polyethylene (polyvinyl chloride), acrylic resin, polycarbonate, and epoxy resin. The base includes a plurality of additive particles selected from the group consisting of pigments, dyes, colorants, coloring matters, and pearl powders. The additive particles are randomly distributed in the base. In this embodiment, the material of the base is a single-component PU resin (U-BEST POLYMER INDUSTRY CO., LTD®, AT-508E™). The additive particles are pearl powder (model: SANFANG SA101S) with a percentage from 0.1% to 4%.

Then, the base is formed on the release paper 31 in the weight distribution of 120 g/m². After that, as described above, an exterior magnetic field is applied to change the orientation of the additive particles. Next, the base is dried to form a surface layer 32 having a surface 321. The surface layer 32 is the same as the above-mentioned resin surface layer.

Next, a first adhesion layer 33 is formed on the surface layer 32. The material of the first adhesion layer 33 is a two-component PU resin (U-BEST POLYMER INDUSTRY CO., LTD®, BD636M™), and has a weight distribution of 120 g/m². Then, the first adhesion layer 33 is dried into a half-dried state at 70° C. After that, a bottom cloth layer 34 is formed on the first adhesion layer 33, and the bottom cloth layer 34 is selected from a group consisting of a woven fabric, a non-woven fabric, leather, a microfiber, and a resin. In this embodiment, the bottom cloth layer 34 is artificial leather (San Fang). Finally, referring to FIG. 11, the release paper 31 is removed and inverted 180 degrees, and thus a composite 3 is formed.

Referring to FIG. 11 again, a schematic view of the first embodiment of a composite having a resin surface layer according to the present invention is shown. The composite 3 is fabricated by the method of the first embodiment. The composite 3 includes a bottom cloth layer 34, a first adhesion layer 33, and a surface layer 32. The bottom cloth layer 34 is artificial leather (San Fang). The first adhesion layer 33 is located on the bottom cloth layer 34, and the material of the first adhesion layer 33 is a two-component PU resin (U-BEST POLYMER INDUSTRY CO., LTD®, BD636M™). The surface layer 32 is located on the first adhesion layer 33. The surface layer 32 has a surface 321. The surface layer 32 has a base and a plurality of additive particles. The material of the base is a resin. The additive particles are in the base. The additive particles are controlled by an exterior magnetic field so as to be arranged in a predetermined form instead of randomly distributed in the base, so that the surface 321 of the surface layer 32 can exhibit the visual effect of 3D texture, although the surface 321 is smooth and does not have a physical texture of bumps and pits.

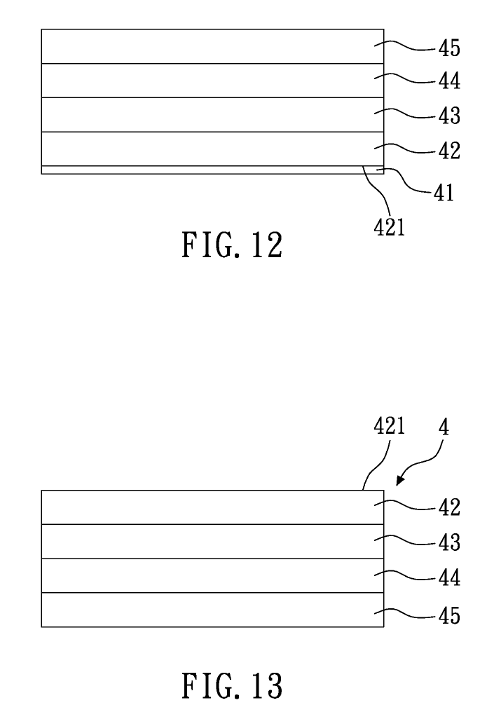

FIGS. 12 and 13 show schematic views illustrating a second embodiment of a method of fabricating the composite having a resin surface layer according to the present invention. First, referring to FIG. 12, a release paper (Favini® ASTRAKAN™) 41 is provided. Next, a base is provided. The material of the base is resin and the base includes a plurality of first additive particles randomly distributed therein. In this embodiment, the material of the base is a single-component PU resin (U-BEST POLYMER INDUSTRY CO., LTD®, AT-508E™). The first additive particles are pearl powder (model: SANFANG SA101S) with a percentage from 0.1% to 4%.

Then, the base is formed on the release paper 41 in the weight distribution of 120 g/m². After that, as described above, an exterior magnetic field is applied to change the orientation of the first additive particles. Next, the base is dried to form a surface layer 42 having a surface 421. The surface layer 42 is the same as the above-mentioned resin surface layer.

Next, an intermediate layer 43 is formed on the surface layer 42. The material of the intermediate layer 43 is resin and the intermediate layer 43 includes a plurality of second additive particles randomly distributed therein. The material of the intermediate layer 43 is selected from a group consisting of PU, polyethylene (polyvinyl chloride), acrylic resin, polycarbonate, and epoxy resin. The second additive particles are selected from a group consisting of pigments, dyes, colorants, coloring matters, and pearl powders. In this embodiment, the material of the intermediate layer 43 is a single-component PU resin (U-BEST POLYMER INDUSTRY CO., LTD®, AT-508E™). The second additive particles are pigment particles, and the material of the pigment is 41P series of TAH KONG CHEMICAL INDUSTRIAL CORP. It is understood that the second additive particles may be pearl powder or a mixture of pearl powder and pigment. Next, the intermediate layer 43 is formed on the surface layer 42 in the weight distribution of 120 g/m². It should be noted that the intermediate layer 43 can be directly dried without any reaction.

Next, a first adhesion layer 44 is formed on the intermediate layer 43. The material of the first adhesion layer 44 is a two-component PU resin (U-BEST POLYMER INDUSTRY CO., LTD®, BD636M™), and has the weight distribution of 120 g/m². Thereafter, the first adhesion layer 44 is dried into a half-dried state at 70° C. Next, a bottom cloth layer 45 is formed on the first adhesion layer 44, and the bottom cloth layer 45 is selected from a group consisting of a woven fabric, a non-woven fabric, leather, a microfiber, and a resin. In this embodiment, the bottom cloth layer 45 is artificial leather (San Fang). Finally, referring to FIG. 13, the release paper 41 is removed and inverted 180 degrees, thus forming a composite 4.

Referring to FIG. 13 again, a schematic view of the second embodiment of a composite having a resin surface layer according to the present invention is shown. The composite 4 is fabricated by the method of the second embodiment and is substantially the same as the composite 3 of the first embodiment, except that the composite 4 further has an intermediate layer 43 between the surface layer 42 and the first adhesion layer 44. The material of the intermediate layer 43 is resin, and the intermediate layer 43 includes a plurality of second additive particles randomly distributed therein.

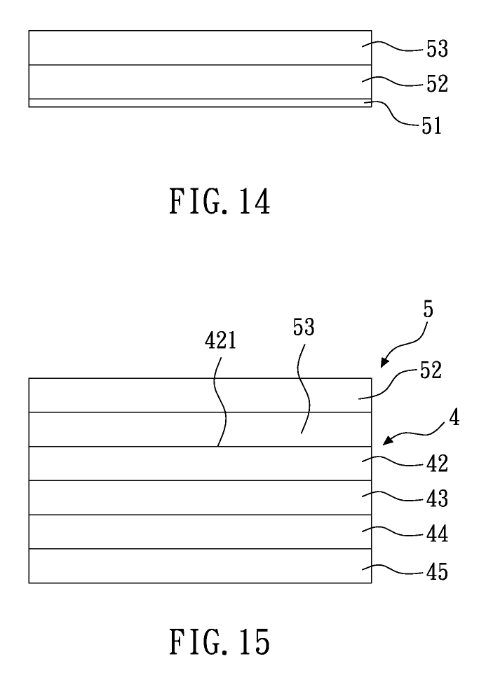

FIGS. 14 and 15 show schematic views illustrating a third embodiment of a method of fabricating the composite having a resin surface layer according to the present invention. The fabrication method of this embodiment occurs subsequent to the second embodiment. First, referring to FIG. 14, a second release paper (Favini® ASTRAKAN™) 51 is provided. Next, a top layer 52 is formed on the second release paper 51. The material of the top layer 52 is resin and the top layer 52 includes a plurality of third additive particles randomly distributed therein. The material of the top layer 52 is selected from a group consisting of PU, polyethylene (polyvinyl chloride), acrylic resin, polycarbonate, and epoxy resin. The third additive particles are selected from the group consisting of pigments, dyes, colorants, coloring matters, and pearl powders. In this embodiment, the material of the top layer 52 is a single-component PU resin (U-BEST POLYMER INDUSTRY CO., LTD®, AT-508E™). The third additive particles are pigment particles, and the material of the pigment is 41P series of TAH KONG CHEMICAL INDUSTRIAL CORP. It is understood that the third additive particles may be pearl powder or a mixture of pearl powder and pigment. Next, the top layer 52 is formed on the second release paper 51 in the weight distribution of 120 g/m². It should be noted that the top layer 52 can be directly dried without any reaction, and the third additive particles are required to have transparency.

Next, a second adhesion layer 53 is formed on the top layer 52. The material of the second adhesion layer 53 is a two-component PU resin (U-BEST POLYMER INDUSTRY CO., LTD®, BD636M™), and has a weight distribution of 120 g/m². Thereafter, the second adhesion layer 53 is dried into a half-dried state at 70° C.

Then, the second release paper 51, the top layer 52, and the second adhesion layer 53 are inverted, so as to adhere the second release paper 51 and the top layer 52 to the surface layer 42 of the composite 4 of the second embodiment by the use of the second adhesion layer 53. Finally, the second release paper 51 is removed, thus obtaining a composite 5.

Referring to FIG. 15 again, a schematic view of the third embodiment of a composite having a resin surface layer according to the present invention is shown. The composite 5 is fabricated by the method of the third embodiment. The composite 5 is substantially the same as the composite 4 of the second embodiment, except that the composite 5 further has a top layer 52 and a second adhesion layer 53. The second adhesion layer 53 is located on the surface layer 42, and the top layer 52 is located on the second adhesion layer 53. The material of the top layer 52 is resin, and the top layer 52 includes a plurality of third additive particles randomly distributed therein. The third additive particles are required to have transparency.

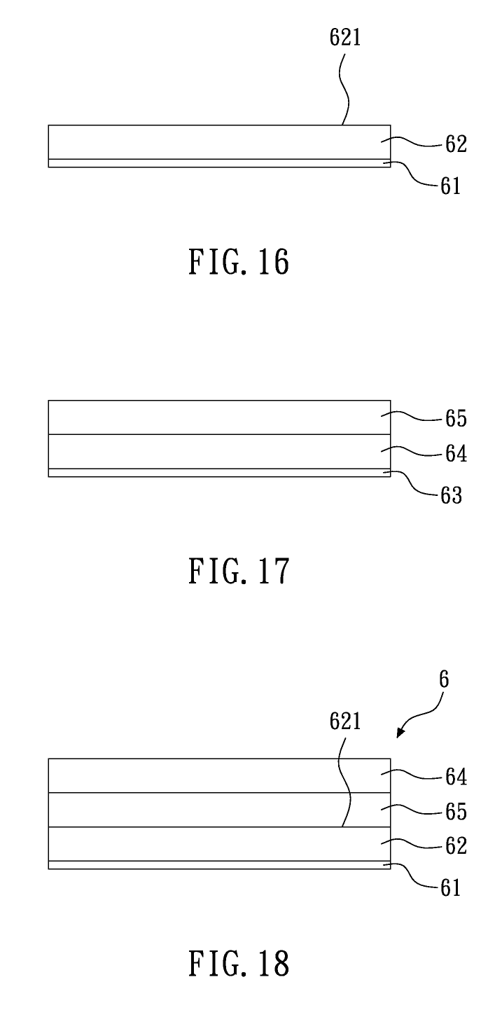

FIGS. 16 and 18 show schematic views illustrating a fourth embodiment of a method of fabricating the composite having a resin surface layer according to the present invention. First, referring to FIG. 16, a bottom cloth layer 61 is provided. The bottom cloth layer 61 is selected from a group consisting of a woven fabric, a non-woven fabric, leather, a microfiber, and a resin. In this embodiment, the bottom cloth layer 61 is artificial leather (San Fang).

Next, a base is provided. The material of the base is a resin selected from the group consisting of PU, polyethylene (polyvinyl chloride), acrylic resin, polycarbonate, and epoxy resin. The base includes a plurality of first additive particles, and the first additive particles are selected from the group consisting of pigments, dyes, colorants, coloring matters, and pearl powders. The first additive particles are randomly distributed in the base. In this embodiment, the material of the base is a single-component PU resin (U-BEST POLYMER INDUSTRY CO., LTD®, AT-508E™). The first additive particles are pigment particles, and the material of the pigment is 41P series of TAH KONG CHEMICAL INDUSTRIAL CORP. It is understood that the first additive particles may be pearl powder or a mixture of pearl powder and pigment.

Then, the base is formed on the bottom cloth layer 61 in the weight distribution of 120 g/m². After that, as described above, an exterior magnetic field is applied to change the orientation of the first additive particles. Next, the base is dried to form a surface layer 62 having a surface 621. The surface layer 62 is the same as the above-mentioned resin surface layer.

Next, referring to FIG. 17, a release paper (Favini® ASTRAKAN™) 63 is provided. Then, a top layer 64 is formed on the release paper 63. The material of the top layer 64 is resin, and the top layer 64 includes a plurality of second additive particles randomly distributed therein. The material of the top layer 64 is selected from a group consisting of PU, polyethylene (polyvinyl chloride), acrylic resin, polycarbonate, and epoxy resin. The second additive particles are selected from a group consisting of pigments, dyes, colorants, coloring matters, and pearl powders. In this embodiment, the material of the top layer 64 is a single-component PU resin (U-BEST POLYMER INDUSTRY CO., LTD®, AT-508E™). The second additive particles are pigment particles, and the material of the pigment is 41P series of TAH KONG CHEMICAL INDUSTRIAL CORP. It is understood that the second additive particles may be pearl powder or a mixture of pearl powder and pigment. Next, the top layer 64 is formed on the release paper 63 in the weight distribution of 120 g/m². It should be noted that the top layer 64 can be directly dried without any reaction, and the second additive particles are required to have transparency.

Next, a first adhesion layer 65 is formed on the top layer 64. The material of the first adhesion layer 65 is a two-component PU resin (U-BEST POLYMER INDUSTRY CO., LTD®, BD636M™), and has a weight distribution of 120 g/m². Thereafter, the first adhesion layer 65 is dried into a half-dried state at 70° C.

Next, referring to FIG. 18, the release paper 63, the top layer 64, and the first adhesion layer 65 are inverted, so as to adhere the release paper 63 and the top layer 64 to the surface 621 of the surface layer 62 by the use of the first adhesion layer 65. Finally, the release paper 63 is removed, thus obtaining a composite 6.

Referring to FIG. 18 again, a schematic view of the fourth embodiment of a composite having a resin surface layer according to the present invention is shown. The composite 6 is fabricated by the method of the third embodiment. The composite 6 includes a bottom cloth layer 61, a surface layer 62, a first adhesion layer 65, and a top layer 64. The bottom cloth layer 61 is artificial leather (San Fang). The surface layer 62 is located on the bottom cloth layer 61. The surface layer 62 has a surface 621. The surface layer 62 has a base and a plurality of first additive particles. The material of the base is a resin, and the first additive particles are controlled by an exterior magnetic field so as to be arranged in a predetermined form instead of randomly distributed in the base, so that the surface 621 of the surface layer 62 can exhibit the visual effect of 3D texture, although the surface 621 of the surface layer 62 is smooth and does not have a physical texture of bumps and pits.

The first adhesion layer 65 is located on the surface layer 62, and the material of the first adhesion layer 65 is a two-component PU resin (U-BEST POLYMER INDUSTRY CO., LTD®, BD636M™). The top layer 64 is located on the first adhesion layer 65. The material of the top layer 64 is resin, and the top layer 64 includes a plurality of second additive particles randomly distributed therein. The second additive particles are required to have transparency.

While several embodiments of the present invention have been illustrated and described, various modifications and improvements can be made by those skilled in the art. The embodiments of the present invention are therefore described in an illustrative but not restrictive sense. It is intended that the present invention should not be limited to the particular forms as illustrated, and that all modifications which maintain the spirit and scope of the present invention are within the scope defined in the appended claims.

What is claimed is:

1. A method of fabricating a resin surface layer, comprising the steps of:
(a) providing a base, made of a resin and including a plurality of additive particles randomly distributed in the base, wherein the additive particles are selected from a group consisting of pigments, dyes, colorants, coloring matters, and pearl powders;
(b) moving the base constantly, and providing a magnetic field generating device to generate an exterior magnetic field that has an uneven distribution of magnetic field intensity, and is applied to the base to change the orientation of the additive particles, so that the additive particles are arranged in a predetermined form; and
(c) drying the base to make a surface of the base exhibit a visual effect of 3D texture.

2. The method as claimed in claim 1, wherein the material of the base in Step (a) is selected from a group consisting of PU, polyethylene (polyvinyl chloride), acrylic resin, polycarbonate, and epoxy resin, and after Step (a), further comprises a step of forming the base on a carrier, and the carrier is selected from a group consisting of a release paper, a woven fabric, a non-woven fabric, leather, a microfiber, and a resin.

3. The method as claimed in claim 1, wherein in Step (b), the distribution or the angle of the additive particles is changed.

4. The method as claimed in claim 1, wherein in Step (b), the magnetic field generating device is a plate magnetic material.

5. The method as claimed in claim 1, wherein in Step (b), the magnetic field generating device comprises a plurality of magnetic materials.

6. The method as claimed in claim 5, wherein the magnetic field generating device further comprises a caterpillar, the magnetic materials are located on the caterpillar, and the moving velocity of the magnetic materials is equal to the moving velocity of the base.

7. The method as claimed in claim 1, wherein in Step (b), the magnetic field generating device comprises a magnetic material and a roller, the magnetic material is annular and located on the periphery of the roller, and the tangent moving velocity of the magnetic material is equal to the moving velocity of the base.

8. A resin surface layer, comprising:
a base, having a surface and made of a resin; and
a plurality of additive particles, located in the base, selected from a group consisting of pigments, dyes, colorants, coloring matters, and pearl powders, the additive particles being controlled by an exterior magnetic field so as to be arranged in a predetermined form, so that the surface of the base exhibits a visual effect of 3D texture.

9. The resin surface layer as claimed in claim 8, wherein the material of the base is selected from a group consisting of PU, polyethylene (polyvinyl chloride), acrylic resin, polycarbonate, and epoxy resin.

10. The resin surface layer as claimed in claim 8, wherein the additive particles have a predetermined difference in density distribution or angle distribution.

11. A method of fabricating a composite having a resin surface layer, comprising the steps of:
(a) providing a release paper;
(b) providing a base, made of a resin and including a plurality of first additive particles randomly distributed in the base, wherein the first additive particles are selected from a group consisting of pigments, dyes, colorants, coloring matters, and pearl powders;
(c) forming the base on the release paper;
(d) moving the base and the release paper constantly, and providing a magnetic field generating device to generate an exterior magnetic field that has an uneven distribution of magnetic field intensity, and is applied to the base to change the orientation of the first additive particles, so that the first additive particles are arranged in a predetermined form;
(e) drying the base to form a surface layer;
(f) forming a first adhesion layer on the surface layer;
(g) forming a bottom cloth layer on the first adhesion layer; and
(h) removing the release paper to form a composite.

12. The method as claimed in claim 11, wherein in Step (d), the magnetic field generating device is a plate magnetic material.

13. The method as claimed in claim 11, wherein in Step (d), the magnetic field generating device comprises a plurality of magnetic materials.

14. The method as claimed in claim 13, wherein the magnetic field generating device further comprises a caterpillar, the magnetic materials are located on the caterpillar, and the moving velocity of the magnetic materials is equal to the moving velocity of the base.

15. The method as claimed in claim 11, wherein in Step (d), the magnetic field generating device comprises a magnetic material and a roller, the magnetic material is annular and located on the periphery of the roller, and the tangent moving velocity of the magnetic material is equal to the moving velocity of the base.

16. The method as claimed in claim 11, after Step (e), further comprising a step of forming an intermediate layer on the surface layer, wherein the first adhesion layer is formed on the intermediate layer in Step (f).

17. The method as claimed in claim 16, wherein the material of the intermediate layer is resin and the intermediate layer comprises a plurality of second additive particles randomly distributed therein.

18. The method as claimed in claim 11, after Step (h), further comprising the steps of:
(i) providing a second release paper;
(j) forming a top layer on the second release paper;
(k) forming a second adhesion layer on the top layer;
(l) adhering the second adhesion layer to the surface layer of the composite, so that the second release paper and the top layer are adhered to the surface layer of the composite; and
(m) removing the second release paper.

19. A composite having a resin surface layer, comprising:
a bottom cloth layer, selected from a group consisting of a woven fabric, a non-woven fabric, leather, a microfiber, and a resin;
a first adhesion layer, located on the bottom cloth layer; and
a surface layer, located on the first adhesion layer and including a base and a plurality of first additive particles, wherein the base is made of a resin and has a surface, the first additive particles are selected from a group consisting of pigments, dyes, colorants, coloring matters, and pearl powders, controlled by an exterior magnetic field so as to be arranged in a predetermined form in the base, so that the surface of the surface layer exhibits a visual effect of 3D texture.

20. The composite as claimed in claim 19, wherein the composite further comprises an intermediate layer between the surface layer and the first adhesion layer, and the material of the intermediate layer is resin and the intermediate layer comprises a plurality of second additive particles randomly distributed therein.

21. The composite as claimed in claim 19, further comprising a second adhesion layer and a top layer, wherein the second adhesion layer is located on the surface layer, and the top layer is located on the second adhesion layer, the material of the top layer is resin, and a plurality of third additive particles is randomly distributed in the top layer.
